(19) United States
(12) Patent Application Publication
(10) Pub. No.: US 2006/0100743 A1
(43) Pub. Date: May 11, 2006

(54) Automated non-invasive real-time acute renal failure detection system

(75) Inventors: Seth Townsend, Skaneateles, NY (US); Christopher Komanski, Orlando, FL (US); Richard Boyer, Cooper City, FL (US); Nathan Tedford, Somerville, MA (US); Derek Fine, Baltimore, MD (US); Robert Star, Bethesda, MD (US)

Correspondence Address: WILMER CUTLER PICKERING HALE AND DORR LLP, 60 STATE STREET, BOSTON, MA, 02109, US

(73) Assignee: Renal Diagnostic Inc., Cambridge, MA (US)

(21) Appl. No.: 11/113,212

(22) Filed: Apr. 22, 2005

Related U.S. Application Data
(60) Provisional application No. 60/564,744, filed on Apr. 23, 2004.

(51) Int. Cl. G05D 21/00

(52) U.S. Cl. 700/266

(57) ABSTRACT

A real-time, non-invasive system and method for determining the level of an analyte of interest in the urine of a patient is disclosed. The system and method uses the measured level of an analyte of interest to detect the onset of acute renal failure (ARF) as early as possible to prevent that patient from developing the disease or mitigating the effects of the disease. The system and method may be used to monitor the recovery of a patient after an ARF diagnosis. Preferably, the analyte of interest is creatinine or urea. The system may be placed in the urine drain line of a patient between a Foley catheter or other urinary drain and a urine collection bag. The system makes substantially continuous measurements of the urine flow rate and the concentration of the analyte of interest to determine the mass excretion rate of the analyte so it may be monitored to detect if the patient experiences a delta change in the mass excretion rate of an analyte that is indicative of the onset of ARF or a change in renal function.

### RELATED APPLICATION

This application claims the priority of: U.S. Provisional Patent Application No. 60/564744, entitled “Automated Non-Invasive Real-Time ARF Detection System and Method Using Modified Raman Technology,” filed on Apr. 22, 2004.

### FIELD OF THE INVENTION

The present invention relates to systems and methods that are used to detect acute renal failure.

### BACKGROUND OF THE INVENTION

Acute renal failure (“ARF”) is a disease that typically has a high mortality rate and affects more that 300,000 people per year that are hospitalized in the United States. Acute renal failure can also be found in the non-intensive care setting. As would be understood, this number would increase significantly if the worldwide cases were considered.

Treatment for the 300,000 patients that have ARF can cost in excess of $8 billion annually in clinical care costs. These costs include increased hospitalization time, acute renal replacement therapy, post-hospitalization outpatient visits, specialized care, prescription drug treatment, and other medical expenses. However, even with this treatment, there still are more than 30,000 deaths annually.

ARF is the sudden loss of the ability of the kidneys to excrete wastes, maintain appropriate effective circulating volume, and maintain electrolyte balance. There are a number of potential causes of kidney damage. A major cause is decreased kidney perfusion due to decreased blood flow as a result of volume depletion with dehydration or overuse of diuresis, trauma, complicated surgery, septic shock, hemorrhage, burns, or severe or complicated illnesses. Another common cause is acute tubular necrosis (“ATN”) due to tissues being deprived of oxygen (ischemia) as a result of prolonged severe lack of kidney perfusion or low oxygen levels in the blood (hypoxia) that may be seen with sepsis, lung disease or heart disease. Low kidney perfusion may also be seen when the renal arteries become acutely blocked either by thrombus, atherosclerotic plaques, or tearing (dissection) of the vessel wall. Other common causes of ARF in hospitalized patients include exposure to medications such as aminoglycosides and some antifungal antibiotics, intravenous contrast agents used for CT scanning and angiography, and other substances, such as immunoglobulin infusions and solvents. Further causes include overexposure to metals, solvents, radiographic contrast materials, certain antibiotics, and other medications or substances. Yet another cause is myoglobinuria caused by rhabdomyolysis (muscle death) due to alcohol or drug abuse, a crush injury, tissue death of muscles from any cause, seizures, medication, excessive use, and other disorders. ARF also may be caused by a direct injury to the kidneys. Still others are infections, such as acute pyelonephritis and septicemia. Other causes are urinary tract obstructions, such as a narrowing of the urinary tract (stricture), tumors, kidney stones, nephrocalcinosis, and enlarged prostate with subsequent acute bilateral obstructive uropathy. Further, ARF may be caused by severe acute nephritis. There may also be disorders of the blood, such as idiopathic thrombocytopenic purpura, transfusion reactions, or other hemolytic disorders, malignant hypertension, and disorders resulting from childbirth, such as bleeding placenta abruptio or placenta previa that cause ARF. Further, it may be caused by autoimmune disorders, such as scleroderma, or hemolytic uremic syndrome in children.

Some of the symptoms of ARF include the following conditions. The patient may experience decreased urine output volume (oliguria, often defined as urine output <400 cc/day) or no urine output (anuria); however, many patients develop so-called non-oliguric acute renal failure even when the urine output remains adequate. Excessive fluid accumulation as a result of inadequate urine output may result in pulmonary edema manifesting as shortness of breath and swelling (edema), particularly in dependent areas such as the legs and feet. There is excessive urination at night. The patient's ankles, feet, and legs experience swelling or there is general swelling from fluid retention. The patient may be experiencing a decrease in sensation in the hands and feet. There also may be a decreased appetite. The patient may have a metallic taste in his/her mouth. Another symptom is experiencing persistent hiccups. Other symptoms are the patient is having changes in mental status or moods; or is experiencing agitation, drowsiness, lethargy, delirium or confusion, coma, difficulty paying attention, hallucinations, hand tremors, nausea or vomiting, vomiting blood, prolonged bleeding, bloody stool, nose bleeds, slow growth in children, flank pain, fatigue, ear or nose buzzing, breath odor, breast development in males, and high blood pressure. Many of these symptoms are commonly observed in chronic renal failure, but can also be observed in acute renal failure less frequently.

A commonly used description of ARF is that it is a precipitous and significant (>50%) decrease in glomerular filtration rate (“GFR”) of the kidneys over a period of hours to days, with an accompanying accumulation of nitrogenous wastes in the body. Although the kidneys perform multiple roles, e.g., metabolic, endocrinologic, fluid and electrolyte balance, GFR is generally accepted as the index for the functioning of the renal mass.

ARF is a common problem in hospitalized patients, particularly in the ICU. Physicians managing hospitalized patients play a critical role in recognizing early ARF, preventing iatrogenic injury, and reversing the course of ARF. Accurate measurement of GFR is problematic in the acute care setting. Therefore, clinical determinations of ARF based on indirect measurements of GFR, e.g., creatinine, blood urea nitrogen (“BUN”), and urine output, are commonly used.

The driving force for glomerular filtration is the pressure gradient (mainly hydrostatic pressure) from the glomerulus to the Bowman space. Glomerular pressure is primarily dependent on renal blood flow (“RBF”) and is controlled by the combined resistances of renal afferent and efferent arterioles. Regardless of the cause of ARF, reductions in RBF represent a common pathologic pathway for decreasing GFR. This may not be true if the cause is obstruction or glomerulonephritis though it can be true with pre-renal renal failure. RBF decrease results in a GFR decrease under conditions where there is hypoperfusion that may be seen with dehydration or other causes of volume depletion. This is commonly observed in patients with congestive heart failure and those who are being treated with diuretics.

The etiology of ARF comprises three main mechanisms: pre-renal failure, intrinsic renal failure, and post-obstructive renal failure. Pre-renal failure is found under the conditions when there is normal tubular and glomerular function, but GFR is depressed by compromised renal perfusion. Intrinsic renal failure includes diseases of the glomerulus, tubule, or interstitium, which can be associated with the release of renal afferent vasoconstrictors. Post-obstructive renal failure initially causes an increase in tubular pressure, which decreases the filtration driving force. This pressure gradient soon equalizes, filtration then ceases, and maintenance of a depressed GFR is then dependent upon renal afferent vasoconstriction.

Depressed RBF, which initially can cause pre-renal renal failure and which can often be acutely reversed, eventually leads to ischemia and cell death. This initial ischemic activity triggers the production of oxygen free radicals and enzymes that continue to cause cell injury even after restoration of RBF. Tubular cellular damage results in the disruption of tight junctions between cells, allowing the back leakage of glomerular filtrate, thus, further depressing effective GFR. In addition, dying cells slough off into the tubules, forming obstructing casts, which further decrease GFR and lead to oliguria. During such period of depressed RBF, the kidneys are particularly vulnerable to further attacks. This is when iatrogenic renal injury is most common.

Recovery from ARF is first dependent upon restoration of RBF. Early RBF normalization predicts a better prognosis for recovery of renal function. In pre-renal failure, restoration of circulating blood volume is usually sufficient. Rapid relief from urinary obstruction in post-renal failure results in a prompt recovery. With intrinsic renal failure, removal of tubular or interstitial toxins and initiation of therapy for glomerular diseases decreases renal afferent vasoconstriction.

Once RBF is restored, the remaining functional nephrons increase their filtration and eventually hypertrophy results. GFR recovery is dependent upon the size of this remnant nephron pool. If the number of remaining nephrons is below some critical value, continued hyperfiltration results in progressive glomerular sclerosis, eventually leading to increased nephron loss. A vicious cycle ensues: continued nephron loss causes more hyperfiltration until complete renal failure results. This has been termed the hyperfiltration theory of renal failure and explains the scenario in which progressive renal failure is frequently observed after apparent recovery from ARF.

Physicians and medical professionals can perform a number of different examinations and tests that can reveal ARF and help rule out other disorders that affect kidney function. They can use a stethoscope to listen for a heart murmur or other sounds related to increased fluid volume. The stethoscope may also be used to listen for crackles from the lungs. Further, if inflammation of the heart lining is present, a pericardial friction rub may be heard with a stethoscope. These are all examinations that may detect the presence of, or potential for developing, ARF.

There are a number of conventional laboratory tests that provide an indication of ARF. These involved changes in the level of certain chemicals over a period of a few days to two weeks. These changes over this time-window have been regarded as “sudden” changes. Indicators of ARF that changed over this time-window were an abnormal urinalysis, increased serum creatinine concentrations (often defined as more than 2 mg/dL), decreased creatinine clearance, increased blood urea nitrogen (“BUN”), increased serum potassium, and arterial blood gas and blood chemistries showing metabolic acidosis. Another indicator of ARF has been through examination of the kidneys by ultrasound where one may see evidence of obstruction, kidney stones or change in kidney texture or size. This also can be determined by abnormal X-rays, CT scans or MRIs. These tests may have revealed that the kidneys were oversized, an indication of ARF.

It has been found that it is frequently more practical to use creatinine clearance as a measure of GFR. Creatinine is naturally produced at a constant rate as a metabolite of muscle creatine. Creatinine is neither reabsorbed nor metabolized by the kidney and is filtered from the blood by the kidney, and is secreted into the urine at a constant rate in healthy patients. Moreover, it is an analyte that may be used in urinalysis because of its relatively constant excretion rate.

The absolute concentrations of urine analytes are not generally clinically useful because of the large fluctuations in the amount of water dilution from sample to sample and person to person. Because of creatinine's steady excretion rate, it has been used as an internal standard to normalize the water variations. As such, other analyte concentrations in urinalysis have been determined based on the measurement of creatinine. The creatinine measurement for these purposes usually is determined over one or more days.

There have been a number of methods for the detection of creatinine in urine. These include Jaffe reactions, artificial chemical creatinine receptors, column switching liquid chromatography, and high performance capillary electrophoresis. Moreover, there have been methods used for spectroscopic creatinine detection and urinalysis. These have included using near-infrared absorption spectra, mid-infrared attenuated total internal reflection spectroscopy, and near-infrared Raman spectroscopy. These uses of Raman spectroscopy were directed to very restrictive analysis methods.

With respect to Raman spectroscopy, when light energy irradiates a sample, most photons are scattered through a Rayleigh scatter (same wavelength as incident light). Some light (0.1% of incident intensity) is also transferred with a Raman shift at frequencies different than the Rayleigh scatter. These Raman shifts are a function of the vibrational properties of the sample, and are specific to the sample. A Raman spectrum can be plotted as intensity of scattered light as a function of wavelength. These spectra are usually reported as wavenumber (1/cm).

Raman spectra have been used to measure the concentrations and, in some cases, function of biological molecules. Sometimes deconvolution of Raman signals can be used to determine individual components of each analyte in a biological sample; however, background fluorescence and biological variability necessitate high-level mathematics to accomplish this. Raman spectroscopy has the advantage that it is highly reproducible, can be used in aqueous samples, and optically clear components for obtaining sample readings can be produced inexpensively.

Raman spectroscopy also has several drawbacks and complications, including low signal-to-noise ratios for less concentrated analyte samples. Additionally, it can be very difficult to subtract baseline Raman signals because they usually vary between samples. The noise in any sample measurement can be reduced by using near-IR excitation; however, this often causes reduced Raman intensity. Additionally, biological interference from trace materials can complicate Raman measurements. These can include hemoglobin, albumin, fat, or cholesterol, as well as any material in the sample that is not being directly measured. Materials that absorb the incident wavelength can make concentration determinations difficult. The amount of interference from self-absorbance is largely a function of apparatus geometry. Historically, Raman spectroscopy instruments have also been large and expensive. This is slowly changing, and there are several Raman systems available that are inexpensively priced and smaller than lab-based apparatuses, but the problems just addressed still remain with these lower priced Raman systems, and, to some degree, the problems may increase because of the decreased sensitivity that accompanies these lower priced systems.

There has been a great need for a non-invasive, real-time method to detect and measure creatinine to indicate the onset of ARF. Such a method should also be adaptable for patients with many different physiological makeups. Moreover, the method should be able to detect and measure changes in urine creatinine or other analytes of interest as early as possible to permit the earliest treatment for the potential onset of ARF and other disease condition. The earlier the signs of ARF are detected, the better the chance that the patient will not develop ARF.

### SUMMARY OF THE INVENTION

The present invention is a real-time or substantially real-time, non-invasive system and method for determining the level of an analyte of interest in the urine or other liquid stream of a patient so that the symptoms of ARF or other disease condition may be detected as earlier as possible. The system and method also may be used to monitor the recovery of a patient after an ARF diagnosis or the diagnosis of other disease conditions. Preferably, the analyte of interest for ARF is creatinine or urea, but other metabolites or biomarkers could be used with the system of the present invention to detect the onset of ARF or other disease condition. The system and method of the present invention could also be used for purposes other than monitoring for ARF or other disease conditions, such as monitoring the general health of patients via urinalysis.

The system and method of the present invention may be constituted by a system that may be positioned in a urine drain line between a Foley catheter or other urinary drain line, and urine collection bag, but could also be used with any input of fluid. Preferably, the system will have two parts. The first is a flowrate sensor subsystem and the second is an analyte detection subsystem.

The flowrate sensor subsystem has two sections. The first section through which urine or another liquid stream being measured flows is disposable. The second that contains the flow rate sensing components is reusable. Preferably, the disposable first section fits into the reusable second section that contains the sensing components.

The flow rate sensor subsystem will monitor the flow rate of the patient's urine or other liquid stream being measured passing through the disposable section. The measurement of the flow rate will be based on a predetermined volume of urine or liquid filling the disposable section in a measured amount of time.

The disposable section of the flow rate sensor subsystem has an additional responsibility in the system and method of the present invention. It will serve as the vessel for holding the urine or other liquid when measurements are made of the analyte of interest in the urine or liquid stream. Accordingly, the disposable section must be constructed so that it does not interfere with an accurate measurement of the analyte of interest in the urine or liquid stream using, for example, Raman spectroscopy.

The analyte detection subsystem preferably will be included in the same device housing with the reusable components of the flow rate sensor subsystem. The analyte detection subsystem, preferably, will include a Raman laser source to irradiate the urine or liquid in the disposable section of the flow rate sensor subsystem. The analyte detection subsystem also has a Raman spectrometer that will detect the level of the analyte of interest after excitation of this analyte at certain frequencies. The measured level of the analyte of interest then will be processed according to the present invention to provide an accurate mass excretion rate of the analyte of interest for the particular patient according to that patient's physiological characteristics. The mass excretion rate will be monitored for changes indicative of ARF or other disease condition, or the general health of the patient, as will be discussed.

The measurement methods of the present invention encompass measurements of the urine or liquid stream in both a flowing and non-flowing manner. According to either of these measurement methods, there is an ability to make real-time or substantially real-time measurements of a desired urine analyte, such as creatinine or urea, or other analytes of interest the liquid stream.

According to the method of the present invention, the real-time or substantial real-time measurements of the mass excretion rate of the analyte of interest are continuously graphed along with the flow rate. In the case of ARF, when a graph of the mass excretion rate shows a change in the level by a predetermined amount, it is an indication that the kidneys are not performing their function and an onset of ARF. This real-time or substantially real-time determination of the delta change in the level of the mass excretion rate will provide an early stage indication of the onset of ARF. This early detection provides the best basis to prevent the patient from developing ARF, and could allow for more successful treatment of ARF once detected or diagnosed, allowing physicians to mitigate the consequences of ARF.

The present invention will be explained in greater detail in the remainder of the specification reference in the attached drawings.

### BRIEF DESCRIPTION OF THE DRAWINGS

FIG. 1 shows a patient in an ICU bed with a Foley catheter and a urine collection bag.

FIG. 2 shows a patient in an ICU bed with the system of the present invention disposed in the line between the Foley catheter and the urine collection bag.

FIG. 3 shows a view of a first embodiment of the system of the present invention.

FIG. 4 shows a view of the disposable section of the flow rate sensor subsystem of the first embodiment of the system of the present invention.

FIG. 5 shows a view of the flow rate sensing components of the flow rate sensor subsystem and analyte sensing components of the analyte measuring subsystem of the first embodiment of the system of the present invention.

FIG. 6 shows a view of the second embodiment of the system of the present invention.

FIGS. 7A and 7B show perspective views of the disposable section of the flow rate sensor subsystem from the Raman spectrometer and Raman laser source positions, respectively.

FIGS. 8A, 8B, and 8C show the method for aligning the laser diode beam for detection of the urine sample level at the horizontal plane between a laser diode/photodiode pair.

FIG. 9 shows a spectral response for creatinine irradiated by a Raman laser source.

FIG. 10 shows a schematic view of the second embodiment of the system of the present invention.

FIG. 11A shows a graph of creatinine levels in urine when there is an onset of ARF.

FIG. 11B shows a graph of creatinine levels in urine when there is recovery from ARF.

### DETAILED DESCRIPTION OF THE DRAWINGS

The present invention is a real-time or substantially real-time, non-invasive system and method for continuously or substantially continuously determining the level of an analyte of interest in the urine or other liquid stream of a patient so that the onset of ARF or other disease condition may be detected as early as possible. The system and method also may be used for monitoring the general health of a patient. Further, the system and method may be used to monitor the recovery of a patient after an ARF diagnosis or the diagnosis of another disease condition. This will either prevent the patient from developing the condition or mitigate the affects of the disease condition because of early detection. In the case of ARF, preferably, the analyte of interest is creatinine or urea. However, it is understood that other analytes in urine may be measured for this or other purposes. It is further to be understood that reference herein to urine as the liquid stream under examination applies equally to other body fluids that may be examined for the detection of constituent materials by the system and method of the present invention and, as such, these actions with respect to other body fluids are within the scope of the present invention.

Although the present invention is being described herein with regard to an ICU setting, it is understood that the invention could be used in any hospital setting where a patient is or can be catheterized to drain urine from the bladder, or another body fluid could be circulated through the system of the present invention Therefore, the system and method of the present invention also could be used in certain chronic care settings such as rehabilitation facilities and nursing homes, and has widespread applications in veterinary medicine.

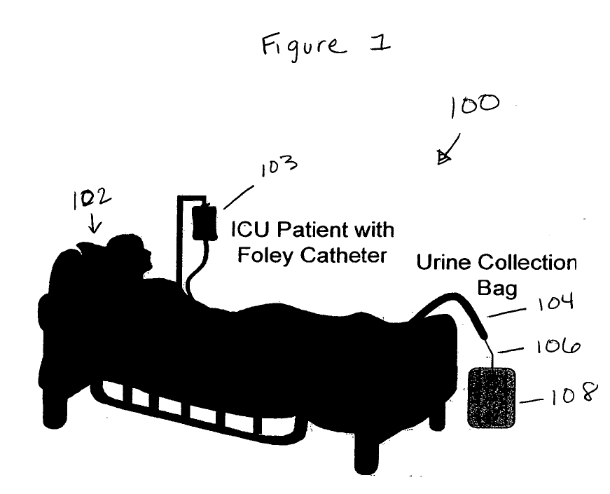

Referring to FIG. 1, generally at 100, a patient in an ICU bed is shown. Patient 102 has intravenous (“IV”) drip bag 103 and a Foley catheter (not shown) connected to him/her. FIG. 1 shows drain line 104 that connects to the Foley catheter. A Foley catheter is a thin, sterile tube inserted into the patient's bladder to drain urine. Approximately, 95% of all ICU patients are fitted with a Foley catheter. The urine from the Foley catheter enters drain line 104 and is deposited in urine collection bag 108 via line 106.

The Foley catheter may be connected to the patient for a long period of time to continuously perform the function of relieving the patient's urine. A nurse or other hospital employee will periodically replace the urine collection bag when it is filled to a predetermined level.

The amount of urine that is produced by a single person may vary during any particular hospital stay. Also, the amount of urine produced by the patient may be affected by the patient's illness or some type of kidney disease. Further, typically, two different people will produce different amounts of urine over a given period of time. Therefore, the measurement of the concentration of an analyte in a sample may not be an accurate measure of that analyte for purposes of predicting, for example, the onset of ARF.

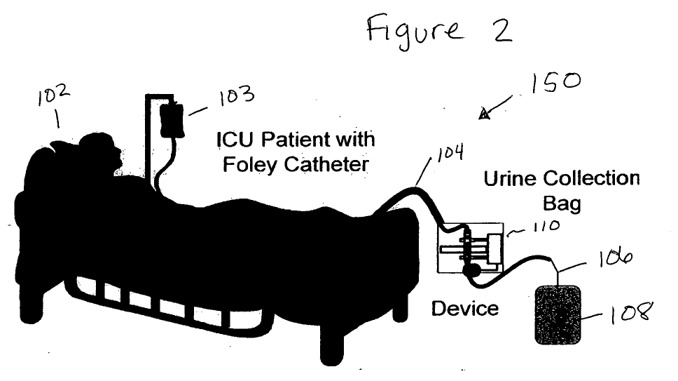

Referring to FIG. 2, generally at 150, a patient in an ICU bed is shown, but with the system of the present invention connected between the Foley catheter and the urine collection bag. Similar to what is shown in FIG. 1, patient 102 in FIG. 2 has IV drip bag 103 and a Foley catheter (not shown) connected to him/her for the removal of urine. Drain line 104 connects to the Foley catheter; however, the drain line does not connect directly to urine collection bag 108 via drain line 106 but to the system of the present invention at 110. The system of the present invention may connect to drain line 104 leading to the Foley catheter and to drain line 106 leading to urine collection bag 108, for example, by luer fittings.

The system of the present invention at 110, among other things, will permit the flow of urine through it in such a manner that it will not impede the regular urine flow from the Foley catheter to the urine collection bag. As such, the system at 110 will not cause a backflow of urine to the Foley catheter and ultimately to the patient.

The purpose of the system and method of the present invention is to make two determinations in real-time or substantially real-time. The first is the urine flow rate of the patient and the second is the mass excretion rate of an analyte of interest, such as creatinine or urea. The first determination is made by measurements carried out by the flow rate sensor subsystem and the second determination is made by the measurements made by the analyte detection subsystem that are processed with the measurements made by the flow rate sensor subsystem. However, it is understood that analytes other than creatinine or urea may be measured for the purpose of the present invention and still be within its scope.

As urine flows from the Foley catheter to urine collection bag 108, the urine is batch sampled by system 110. Once the batch urine sample is tested, it is then sent to the urine bag. Following the release of the batch urine sample from the system of the present invention to the urine collection bag, another batch sample fills the system for effecting the two determinations previously discussed. Accordingly, these determinations are continuously being made or made at some predetermined time interval.

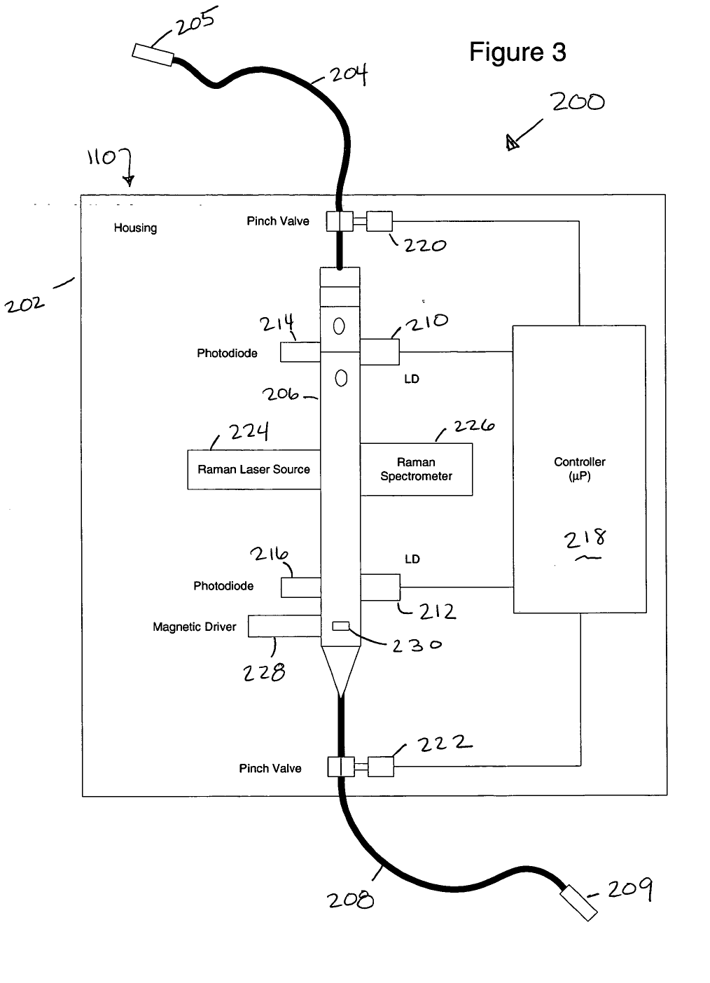

FIG. 3, generally at 200, shows a first embodiment of the system of the present invention. This Figure shows the two subsystems that form the present invention. They are both contained within housing 202. As stated, the two subsystems are the flow rate sensor subsystem and the analyte detection subsystem. The two subsystems are controlled by controller 218 that preferably is a microcontroller (“μP”). This controller may be any combinational logic device.

The first component of the flow rate sensor subsystem is cuvette 206 with in-flow line 204 connected to the top and out-flow line 208 connected to the bottom. In-flow line 204, preferably, has female luer fitting 205 attached to it and out-flow line 208 has male luer fitting 209 connected to it. These fittings are for connecting to the drain line of the Foley catheter and the drain line to the urine collection bag, respectively. Although luer fittings have been described as being disposed at the ends of the in-flow and out-flow lines, it is understood that other fittings may be used and still be within the scope of the present invention.

The next components of the flow rate sensor subsystem are laser diodes (“LDs”) 210 and 212 and their companion photodiodes 214 and 216, respectively. The LDs and photodiodes are controlled by controller 218. Each LD emits an energy beam at a predetermined frequency that impinges on its companion photodiode. The photodiode will sense this energy and produce an output signal.

The lower LD/photodiode pair 212/216 will sense when urine fills cuvette 206 to the point of their location. At this time, a timer (not shown) begins measuring the time to fill the cuvette to the location of the upper LD/photodiode pair 210/214. The time measurement is input to controller 218. This measurement along with the known volume of the cuvette between the two LD/photodiode pairs will be used to determine the flow rate for the patient. Although the invention has been described using a LD, it is understood that a light emitting diode (“LED”) or similar energy source could be used and still be within the scope of the present invention. Further, an electronic/mechanical switch also could be used and still be within the scope of the present invention.

The flow rate sensor subsystem also includes upper pinch valve 220 and lower pinch valve 222. As will be described in detail subsequently, the two pinch valves are under the control of controller 218.

According to the method of the present invention, in order to obtain measurements of the batch urine samples of the analyte of interest, lower pinch valve 222 will be closed and cuvette 206 will begin to fill. When the urine reaches LD/photodiode pair 212/216, a timer begins to measure the time it takes to fill the cuvette to upper LD/photodiode pair 210/214. Upper pinch valve 220 will remain open during the fill operation until the urine level reaches upper LD/photodiode pair 210/214, at which time it will close and the measurement of the analyte of interest will take place. After the measurement is made, the lower pinch valve will open to drain the cuvette with the upper pinch valve closed. When the cuvette is drained, the lower pinch valve will close and the upper pinch valve will open so that the next batch urine sample can be measured.

The flow rate sensor subsystem also includes magnetic driver 228 disposed adjacent to cuvette 206. Magnetic driver 228 is under the control of controller 218. Cuvette 206 has magnetic stir element 230 disposed in it. Magnetic driver 228 is activated as the urine fills the cuvette. This will cause magnetic stir element 230 to stir the urine so that sediment and particulate will be disbursed in the batch sample and will not adversely affect the measurements being taken according to the method of the present invention.

The second subsystem of the system of the present invention is the analyte detection subsystem. Preferably, this subsystem includes Raman laser source 224 and Raman spectrometer 226. An example of a Raman laser source includes an 830 nm, 200 mW laser diode from Process Instruments, Inc. and an example of a Raman spectrometer includes Holoprobe Raman Spectrometer from Kaiser, Inc.

The Raman laser source will irradiate the batch urine sample in cuvette 206. This will cause the excitation of the molecular bonds of the analyte of interest, which causes a spectral response in a definitive frequency band or bands that is unique for that analyte. The characteristics of the response provide a basis for the determination of the concentration of the analyte of interest in the batch urine sample.

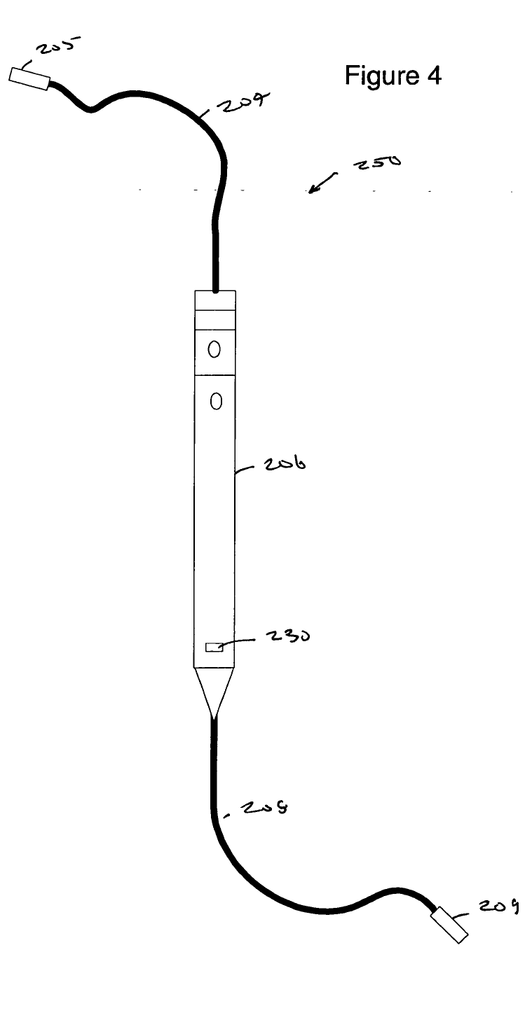

Referring to FIG. 4, generally at 250, the disposable section of the flow rate sensor subsystem is shown. The components shown in FIG. 4 are detachable from the flow rate sensing components that are reusable. Once the disposable section that includes cuvette 206, magnetic stir element 230 in cuvette 206, in-flow line 204 with luer fitting 205, and out-flow line 208 with luer fitting 209, is used for a patient, it may be discarded according to best medical practices, while the reusable section will have a new disposable section connected to it for the next patient.

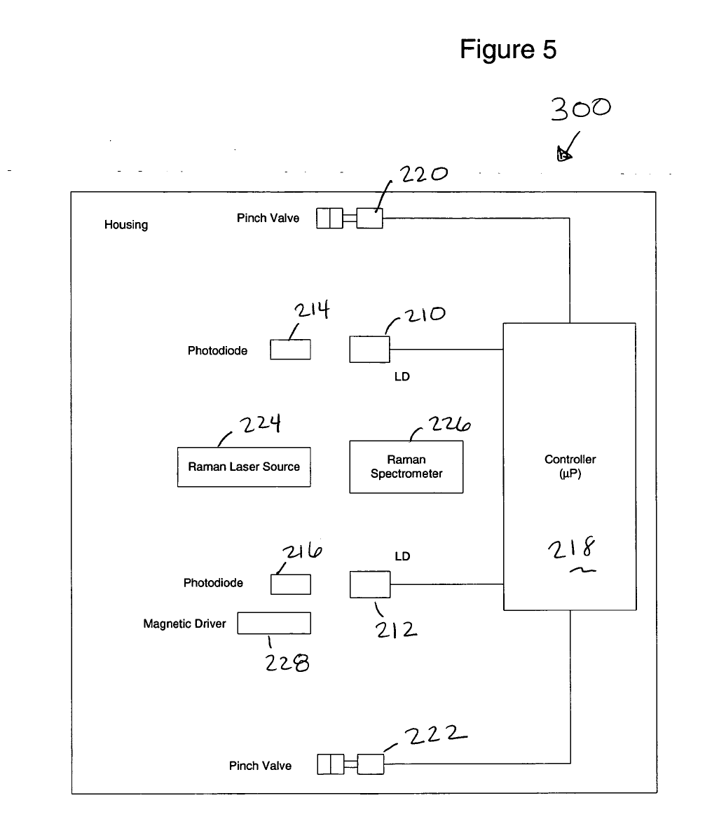

Referring to FIG. 5, generally at 300, the reusable section of the flow rate detection subsystem that is shown in FIG. 3 is shown without the disposable section connected to it. This Figure also shows the analyte detection subsystem and its components.

LD/photodiode pairs 210/214 and 212/216 will determine when the urine level is present across the horizontal plane in the disposable section by a change in the energy at the LD wavelength impinging on the corresponding photodiode. The outputs of the photodiodes are processed by controller 218 to open and close pinch valves 220 and 222, and control the timer to measure the fill time of the cuvette, as previously described. The measurements of the fill time and volume filled in that time are transmitted to a remote or integrated computer (not shown) for processing for determining the flow rate and mass excretion rate for that patient, as will be described. The transmissions to the remote or integrated computer may be via a wired or wireless connection. Preferably, the connection is a wireless connection. Hereinafter, reference to a “remote computer” shall mean “remote or integrated computer.”

The components of the analyte detection subsystem also are shown in FIG. 5. When Raman laser source 224 irradiates the urine in the cuvette, it causes a change in the vibrational frequency of the molecular bonds of the analyte(s) of interest. Cuvette 206 is designed to allow a high transmission of a selected wavelength of interest for detection of the analyte of interest. As such, there is a unique Raman shift for the analyte(s) of interest that is detected by Raman spectrometer 226. The Raman laser source and the Raman spectrometer may be fitted with conventional optics, such as lenses and filters for effecting their proper operation for the detection of the concentration of the analyte of interest. A monochromatic bandpass filter or grating filter that will isolate a narrow frequency band may be used to isolate a single Raman peak for the analyte of interest. As stated, the Raman spectral response is sent to the remote computer (not shown) for a determination of the mass excretion rate of the analyte of interest for the patient.

The use of the Raman laser source has the advantage of enabling the analysis of the batch urine sample without altering the sample in any way. Moreover, the use of the Raman laser source will not interfere with other conventional urinalysis that may be desired to be carried out on the urine of the patient, such as urine electrolyte tests, standard urine microscopy for cell counts, urine drug tests, or urine dipstick tests.

The remote computer will take the inputs just described, process them, and display the flow rate of urine for the patient and the mass excretion rate of the analytes of interest. The remote will continuously monitor the flow rate to determine if there is a predetermined delta change which would indicate the onset of a disease or other problem condition. If such a condition is detected, the remote will trigger an alarm. This alarm may be an audible and/or a visual alarm and still be within the scope of the present invention.

Further, the remote also will continuously monitor the mass excretion rate to determine if the analyte of interest has a predetermined delta change that would connote the onset of ARF. If such a condition is detected, the remote computer can cause an alarm to be triggered. The alarm may be an audible and/or a visual alarm, and still be within the scope of the present invention. The system of the present invention will also record the volume flow rate over time for tracking the general physiological health of a patient. The computer and output screen could also be an integrated part of the system of the present invention.

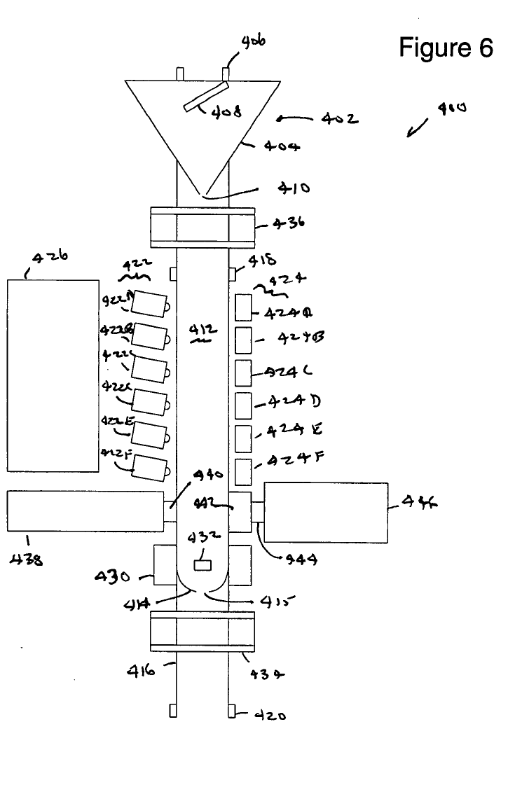

Referring to FIG. 6, generally at 400, a second embodiment of the system of the present invention is shown. The second embodiment, like the first embodiment shown in FIG. 3, has two subsystems: the flow rate sensor subsystem and the analyte detection subsystem. The flow rate sensor subsystem includes two sections: the disposable section and the reusable section. However, each of these sections is constructed differently from its counterpart in FIG. 3, as will be explained. The analyte detection subsystem is substantially the same as its counterpart shown in FIG. 3.

Disposable section 402 of the flow rate sensor subsystem includes cuvette 412 that has overflow subsection 404 disposed at the top. The overflow subsection may have a conical shape with the bottom of the cone extending into the cuvette. The bottom of the cone has opening 410 for permitting the flow of urine from the overflow subsection into the cuvette.

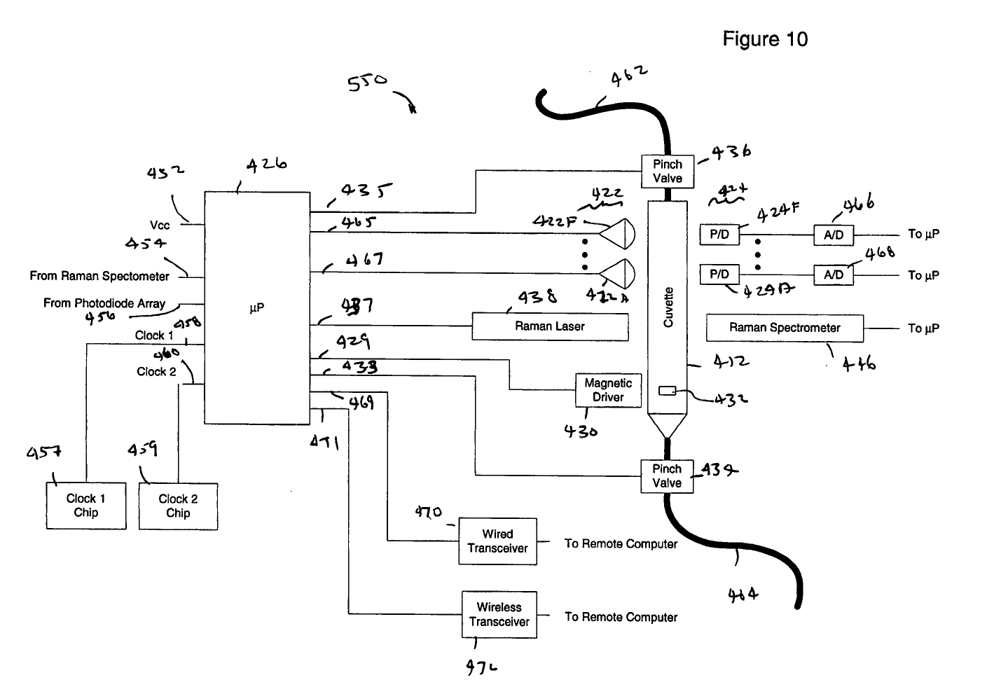

The top of the overflow subsection is closed except for opening 406 to which in-flow line 462 (FIG. 10) from the Foley catheter connects. The overflow subsection also has overflow valve 408 that will float to a closed position if the overflow subsection should fill with urine. The closing of the overflow valve will prevent any backflow of urine to the patient via the in-flow line and the Foley catheter. The overflow subsection may be caused to overflow if the disposable section malfunctions or the volume of urine the patient is producing exceeds the capacity of the system to process in a normal manner.

It is within the scope of the present invention that overflow subsection 404 could have a mechanism that connects to it that would permit excess urine to be removed from the overflow subsection if overflow valve 408 is closed. Moreover, it is within the scope of the present invention that in-flow line 462 may have a relief or bypass valve connected to it under the control of controller 426. This mechanism does not have to be electrically controlled and can be purely hydrostatic or mechanical. This valve may be activated by overflow valve 408 closing. If this happens, the valve will channel the urine flow away from the system of the present invention so that the urine will not backup to the patient via the in-flow line and the Foley catheter. The drain line from the relief or bypass valve may connect to outflow line 464 (FIG. 10) to empty the urine into the urine collection bag.

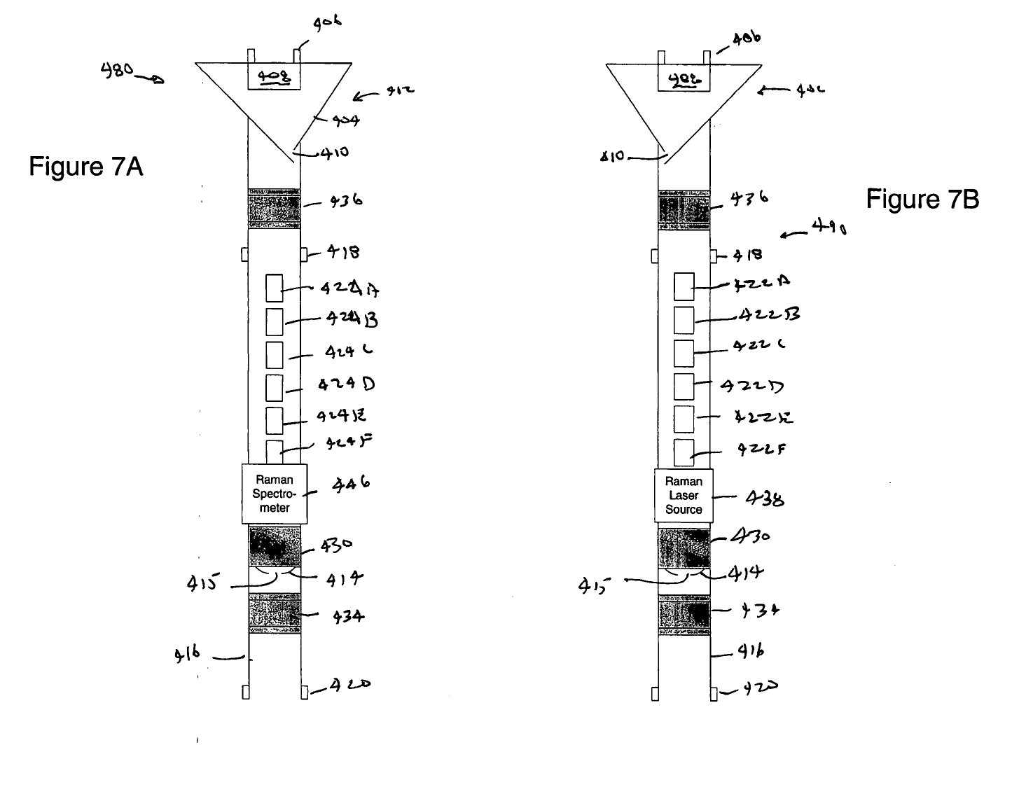

Referring to FIG. 7A, generally at 480, and FIG. 7B, generally at 490, along with FIG. 6, perspective views are shown of the relationship of overflow subsection 404 and cuvette 412 of disposable section 402. According to these Figures, opening 410 at the bottom of the cone of overflow subsection 404 is disposed adjacent to the sidewall of the cuvette 412. This will permit the urine from the overflow subsection to fill the cuvette along the side, thus reducing the interference that could cause false readings as urine fills the cuvette.

Lower part 416 of cuvette 412 has restrictor 414 disposed across it. The restrictor has opening 415 for the egress of urine from the cuvette. Opening 415 has a size that is smaller than magnetic stir element 432 that is positioned in the cuvette but the size of opening 415 will not adversely affect the filling or draining operations of cuvette 412.

Lower part 416 of cuvette 412 will connect to out-flow line 464 (FIG. 10). The out-flow line connects to a urine collection bag (not shown). As stated, the out-flow line may be connected to the overflow subsection 404, or to a relief or bypass valve in in-flow line 462 so that overflow urine may be channeled to the urine collection bag in case the system of the present invention malfunctions to prevent the backup of urine to the patient via in-flow line 462 and the Foley catheter.

The reusable section of the flow rate sensor subsystem, among other things, includes snap clamps 418 and 420 to releasably attach the disposable section of the flow rate sensor subsystem to the reusable section. The reusable section also includes pinch valves 434 and 436. The two pinch valves operate similar to the way their counterparts were described for the first embodiment shown in FIG. 3, except that because the second embodiment uses an array of LD/photodiode pairs, different fill levels may be selected depending on the urine output of the patient.

The reusable section of the flow rate sensor subsystem includes an array of LDs 422 and a corresponding array of photodiodes 424. As shown, LD 422A is paired with photodiode 424A, LD 422B is paired with photodiode 424B, LD 422C is paired with photodiode 424C, LD 422D is paired with photodiode 424D, LD 422E is paired with photodiode 424E, and LD 422F is paired with photodiode 424F. Although the invention has been described using LDs, it is understood that LEDs or similar energy sources could be used and still be within the scope of the present invention. Further, an electronic/mechanical switch also could be used and still be within the scope of the present invention.

When cuvette 412 is being filled with urine, the filling operation is timed from the point that LD 422A/photodiode 424A pair is activated by the level of the urine reaching the horizontal plane between the pair. The successive pairs will be activated as the cuvette is filled with urine until the desired level is reached.

When any of the LD/photodiode pairs is activated, the signal output from the photodiode is input to controller 426. As will be discussed, these signals will be used by the remote computer for determining the flow rate of the patient.

Raman spectrometer 446 is positioned adjacent to cuvette 412, opposite Raman laser source 438. However, the Raman spectrometer may be placed at different locations with respect to the Raman laser source depending on the detection method selected. For example, the system may be constructed for the Raman spectrometer to be positioned for the collection of backscattered energy or at 90 degrees to the incident laser beam and still be within the scope of the present invention.

The ability to select fill levels also will permit the system to be operated in a flowing or non-flowing manner. As such, the system may be operated to fill the cuvette with urine with bottom pinch valve 434 closed and when filled, close top pinch valve 436, make the measurements with the Raman laser source and spectrometer, and then open bottom pinch valve 434 with top pinch valve 436 still closed to empty the cuvette before refilling it with the next batch urine sample.

The system also may be operated in a flowing manner in which bottom pinch valve 434 and top pinch valve 436 are controlled by controller 426 such that a fixed volume of urine will pass through the cuvette in a predetermined period of time. This method will include periodic measurements for determining flow rate for the patient according to the method described previously. The measurements of the analyte of interest will be made at given time intervals as each new batch urine sample passes through the cuvette.

Further, the system may be operated in a flowing manner from the standpoint of the in-flow line. According to this method, with bottom pinch valve 434 closed, top pinch valve 436 will be controlled by controller 426 to provide urine according to the flow output to the patient. The array of LD/photodiode pairs will note the level of the urine in the cuvette. As the urine level passes a predetermined LD/photodiode pair, the system will prepare to make the measurement of the analyte of interest. As the next LD/photodiode pair is activated, it will trigger measurement of the analyte of interest and, thereafter, bottom pinch valve 434 is opened to empty the batch urine sample just measured. Once emptied, the bottom pinch valve will be closed and the process will be repeated. Like the previous non-flowing method, periodic measurement for the flow rate must be carried out. Each of the flowing methods still provides sufficient information for determining the flow rate and mass excretion rate for a patient.

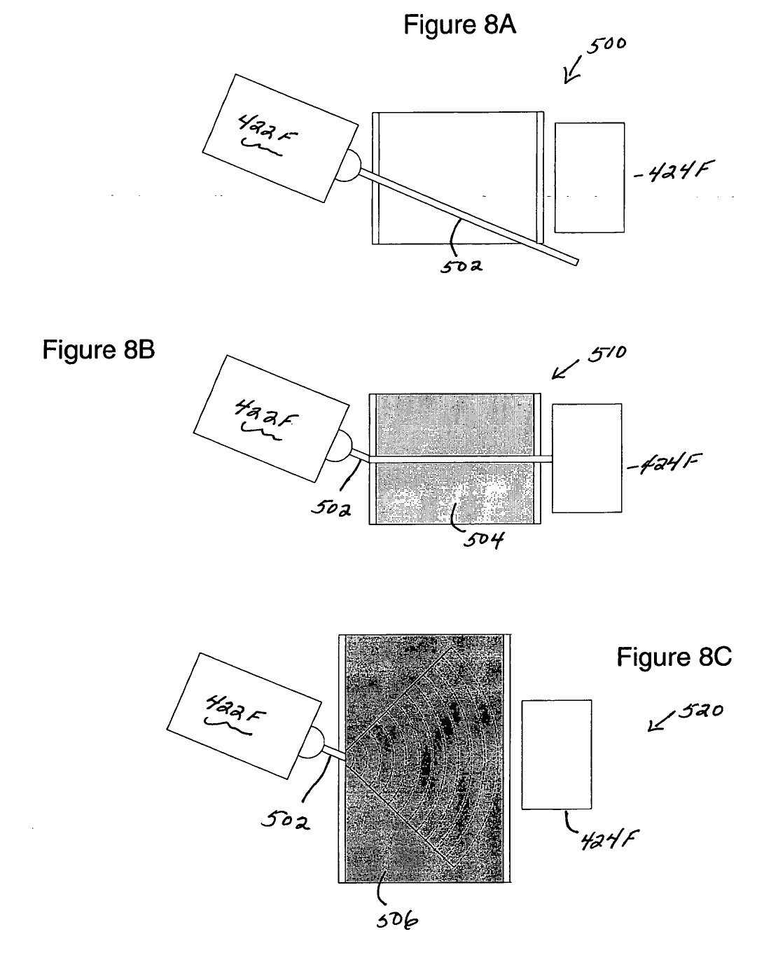

Referring to FIGS. 8A, generally at 500, 8B, generally at 510, and 8C, generally at 520, the operation of the LD/photodiode pairs will be described. The description that follows is applicable for each of the LD/photodiode pairs shown in FIG. 6, namely, LD 422A/photodiode 424A, LD 422B/photodiode 424B, LD 422C/photodiode 424C, LD 422D/photodiode 424D, LD 422E/photodiode 424E, and LD 422F/photodiode 424F. Referring to FIG. 8A, each LD, such as LD 422F that is shown, is positioned so that its beam, such as beam 502, is directed in a manner so that it will not be detected by its paired photodiode, such as photodiode 424F, when cuvette 412 is empty. That is, under this condition, beam 502 will not impinge on the photodiode. Thus, there will be no signal output from the photodiode.

Referring now to FIG. 8B, as urine fills cuvette 412 and reaches the horizontal plane between LD 422F and photodiode 424F, beam 502 is refracted so that it will impinge on photodiode 424F. This will cause the photodiode to generate an output that is input to controller 426 to indicate the urine level has reached that LD/photodiode pair. This could cause other actions to be initiated, for example, the closing of upper pinch valve 436 (FIG. 6) and the measurement of the analyte of interest. In FIG. 8B, if urine 504 is reasonably transparent, beam 502 will not be substantially diffused and a strong signal will be generated by photodiode 424F.

Referring to FIG. 8C, the same type of refractive alignment of beam 502 takes place as was described for FIG. 8B. However, in this situation, urine 506 is substantially more opaque than urine 504 shown in FIG. 8B. The more opaque the urine, the more beam 502 will be diffused as shown in FIG. 8C. The photodiode will still generate a signal to indicate that the urine level has reached the horizontal plane between the LD and photodiode, but this signal will not be as strong as the one produced in the situation shown in FIG. 8B. Therefore, the photodiodes should be selected with the appropriate sensitivity to generate an appropriate level signal under the conditions in which the system of the present invention will be used.

The present invention has been described as using a refractive alignment method for determining the level of the urine in the cuvette. It is understood that other methods may be used and still be within the scope of the present invention. For example, the LD/photodiode pairs may be positioned such that the beam from the LD always impinges on the photodiode and when the urine level rises to the horizontal plane between the two, the signal output by the photodiode would drop to indicate this event.

Again referring to FIG. 6, the analyte detection subsystem includes as its principal elements Raman laser source 438 and Raman spectrometer 446. Examples of these elements have been provided previously. The Raman laser source is disposed adjacent to one sidewall of cuvette 412. The cuvette walls are substantially transparent to the Raman laser energy. Preferably, the output of the Raman laser source is processed by an appropriate optical filter 440 so that the desired frequency of energy from the Raman laser source impinges on the batch urine sample in the cuvette. An example of an optical filter that may be used includes a notch/grating filter.

Preferably, the response caused by the excitation of the analyte of interest by the Raman laser source will be processed by light gathering optics 442 and optical filter 444 before being input to Raman spectrometer 446. An example of light gathering optics 442 includes a columnating lens and optical filter 444 includes a notch/grating filter. The output of the Raman spectrometer will be input to controller 426 for processing and transmission to the remote computer.

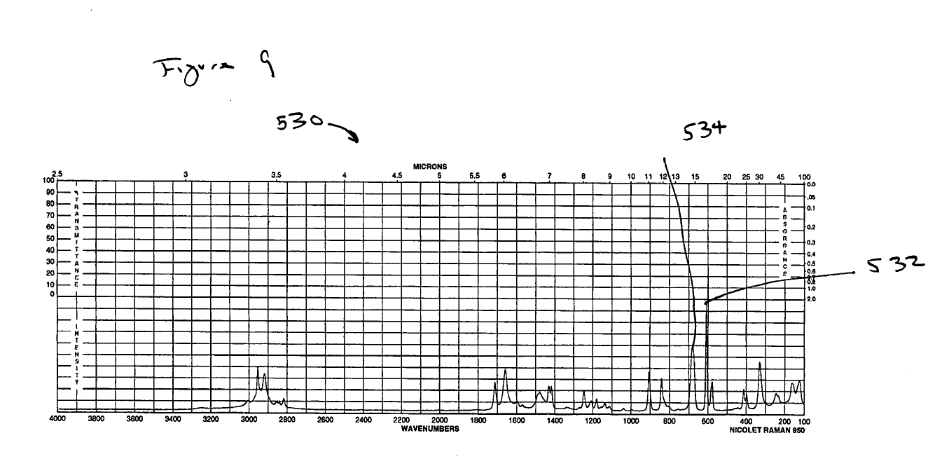

Referring to FIG. 9, the response from Raman spectrometer 446 is shown generally at 530. Raman laser source is specifically set for the excitation of the molecular bonds of the analyte of interest. For example, if the analyte of interest is creatinine, the Raman laser source would be set, for example, for the excitation of the analyte to produce a response in the 600-800 wavenumber range since that is where the peaks, such as those shown at 532 and 534, will be found if there is creatinine in the batch urine sample. It is understood that there are many other identifiable peaks associated with creatinine that also could be used to identify the molecule, either individually or in parallel with those shown in FIG. 9. It also is understood that if another analyte was selected, such as urea, the same process would be used but for this analyte instead of creatinine.

Again referring to FIG. 6, cuvette 412 has magnetic drive 430 disposed adjacent to it, close to the location of restrictor 414. The magnetic drive is under the control of controller 426. When the magnetic drive is activated, it will cause magnetic stir element 432 to spin in cuvette 412 to stir the batch urine sample in the cuvette. Stirring the urine in this manner will help prevent sediment and other particulates in the urine from causing false measurements by the system of the present invention. An example of a magnetic drive includes a miniaturized VWR magnetic stirplate.

Referring to FIG. 10, generally at 550, a schematic view of the second embodiment of the system of the invention is shown. Controller or μP 426 is used to control the system of the present invention. The first input to μP 426 is V_{CC} at 452. This signal is used for powering all of the electronic components of the system of the present invention. The second input is the signal at 454 that is output from Raman spectrometer 446. This signal is sent to the remote computer and processed to provide the measurement of the concentration of the analyte of interest in the batch urine sample.

The third input to μP 426 is the signal at 456 that is representative of the signals output by photodiode array 424 after processing each of the signals with an analog-to-digital converter (“A/D”). These signals represent the activation of the LED/photodiode pairs as urine fills the cuvette. The analog signal output from photodiode 424F is input to A/D 466, which converts it to a digital signal. The digital signal is input to μP 426 at 456. In a similar manner, the analog signal output from photodiode 424A is input to A/D 468, which converts it to a digital signal that is input to the μP at 456. The two photodiodes that are shown, 424F and 424A, are meant to be representative of photodiode array 424 shown in FIG. 6. It is understood that each photodiode may have an individual input to μP 426.

The fourth input to μP 426 is at 458 and it is the clock 1 signal output from clock 1 chip 457. The clock 1 signal is used to control the clocking of the μP and any other electronic components of the system of the present invention.

The fifth input to μP 426 is at 460 and this is the clock 2 signal output flow clock 2 chip 459. The clock 2 signal is a time measurement signal that is triggered and stopped by predetermined LD/photodiode pairs being activated. It will time the filling of the cuvette with urine to a predetermined level. Preferably, the time is triggered when the LD 422A/photodiode 424A is activated. It will time until the final LD/photodiode pair 422F/424F is activated which will stop it. This time value will be used from determining the flow rate and mass excretion rate for the patient, as will be described subsequently. The system could be designed using a single clock chip with altered software control of timing for volume flow rate determination.

The system may be controlled so that there may be measurements of the flow rate and mass excretion rate either as the total flow rate and/or total mass excretion rate, or these measurements may be made at discrete or predetermined times.

The first output from μP 426 at 435 is the signal to control top pinch valve 436. As stated, pinch valve 436 controls the flow of urine from in-flow line 462 into cuvette 412.

The second output of μP 426 at 465 is for driving LD 422F and the third output at 467 is for driving LD 422A. These LDs are meant to be representative of LD array 422 shown in FIG. 6.

The output at 437 is the drive signal for Raman laser source 438. This signal will control the activation and deactivation of the Raman laser source so that for each batch urine sample a signal will be generated indicative of the analyte of interest in the urine.

The next signal, the fifth output from μP 426, is at 429 and is the drive signal for the magnetic driver 430. When the magnetic driver is activated under the control of the μP, it will cause magnetic stir element 432 to stir batch urine sample in the cuvette for the previously described purposes.

The sixth output from μP 426 at 433 is the signal to control lower pinch valve 434. As stated, pinch valve 434 controls the flow of urine from cuvette 412 to out-flow line 464 that connects to the urine collection bag.

The last two outputs of μP 426 are the signals at 469 and 471. The output at 469 is input to wired transceiver 470. The output at 471 is input to wireless transceiver 472. Therefore, it is understood that the system of the present invention can communicate with the remote computer in either a wired or wireless way and still be within the scope of the present invention.

It is understood that what is shown in FIG. 10 with regard to cuvette 412 is meant to be representative of the disposable section that is shown in FIG. 6. Similarly, it is understood that what is shown in FIG. 10 with regard to Raman laser 438, Raman spectrometer 446 and the other components are representative of the assemblies shown in FIG. 6.

The information that μP 426, as well as controller 218 in FIG. 3, transmits to the remote computer is the volume determination based on the LD/photodiode pairs activated, the time it took to fill the cuvette to the predetermined volume as measured by the clock 2 signal, and the measurement of the concentration of the analyte of interest as measured by the Raman spectrometer. The remote computer is programmed to at least determine and display the flow rate of urine and mass excretion rate of the patient so that as the analyte of interest is being monitored for the patient over time, there can be a rapid determination of a predetermined delta change in the mass excretion rate for patients which is an early indicator of the onset of ARF. Accordingly, since the volume of the cuvette and the time to fill that volume is provided from μP 426 (and controller 218), the flow rate for the urine can be determine by the remote computer. As such, the remote computer will determine the flow rate for the patient according to the following expression:

$$FR = \frac{Volume}{Time} \qquad ( 1 )$$

Where,

FR=Flowrate of urine in the cuvette

Volume=The known volume of cuvette being filled

Time=Time to fill known volume of cuvette

The remote will continuously monitor the flow rate to determine if there is a predetermined delta change that would indicate the onset of a disease or other problem condition. If such a condition is detected, an alarm may be activated. The alarm may be audible, visual, or both. This alarm may be local to the device, local to the remote, and/or sent to the central ICU computing system.

As stated, the remote computer will also determine the mass excretion rate for the patient. This value can and typically will be different for each patient. It is necessary to determine this value so it may be a monitored for a delta change. The mass excretion rate may be determined by the remote computer according to the following expression:

$$\begin{matrix}ME = ( Flowrate ) ( Concentration ) \\ ME = ( \frac{Volume}{Time} ) ( \frac{Mass}{Volume} ) = ( \frac{Mass}{Time} )\end{matrix} \qquad ( 2 )$$

Where,

ME=Mass excretion rate of analyte of interest

Volume=The known volume of cuvette being filled

Time=Time to fill known volume of cuvette

Mass=Measured mass of analyte of interest

The determination of the mass excretion rate of the analyte of interest will yield a substantially steady state value as long as there is no onset of ARF.

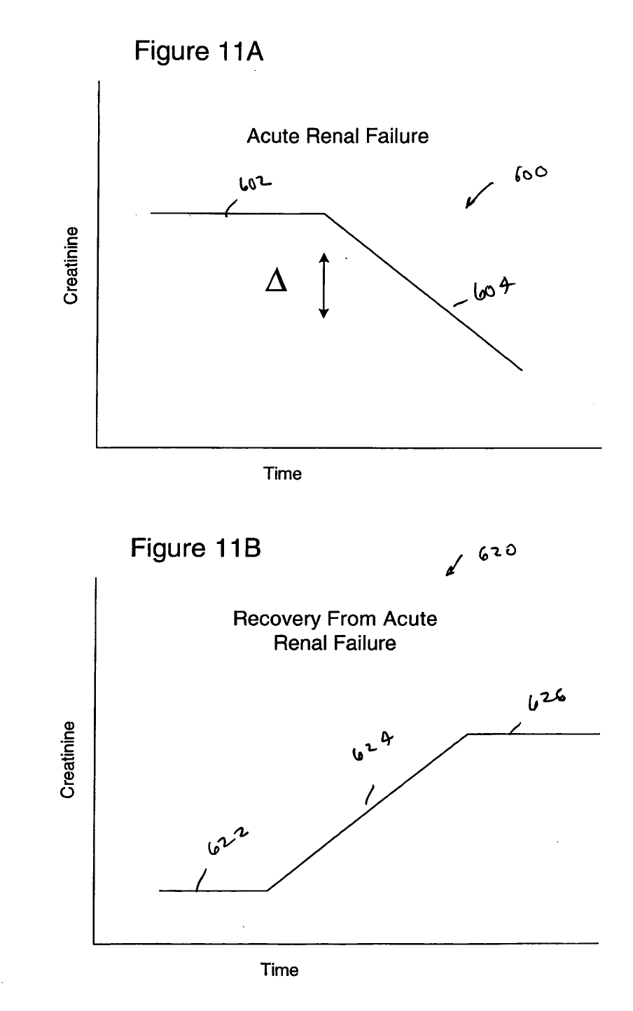

Once a patient's normal mass excretion rate is determined, it will be graphed. If the analyte of interest is creatinine, a mass excretion rate graph for normal excretion and excretion in the presence of the onset of ARF is shown in FIG. 11A generally at 600. The normal mass excretion rate of creatinine is shown at 602. However, if there is the onset of ARF, the mass excretion rate will decrease as shown at 604. When there is a predetermined downward delta change, the system will provide an alarm to indicate the onset of ARF. The alarm may be audible, visual, or both. The alarm may be local to the device, local to the remote, and/or sent to the central ICU computing system. Since the mass excretion rate of creatinine is continuously monitored, the alarm condition may be set as desired. As such, it may be set to be triggered at a very small delta change for a patient who is prone to ARF and a greater delta change for a patient who is not likely to develop ARF. The system of the present invention is robust and as such, the delta change in the mass excretion rate of creatinine may be determined in less than 4-6 hours where conventional methods would take a day or more, thereby putting the patient at risk of having ARF.

If a patient does experience ARF, the system of the present invention may also be used to monitor the recovery of the patient. Referring to FIG. 11B, generally at 620, a graph of the recovery of a patient from ARF is shown. The graph at 622 shows the mass excretion rate of creatinine of the patient when experiencing ARF. As the patient is treated for ARF and he/she is responding, the mass excretion rate of creatinine will improve along the graph at 624. When the patient has recovered from ARF he/she will return to their normal mass excretion rate of creatinine at 626.

Although the present invention has been described as including a controller (or μP) and a remote computer, it is understood that a single device may carry out the functions of both devices and still be within the scope of the present invention. The microcontroller also can be made to perform more functions before sending information to the computer.

The terms and expressions that are employed herein are terms or descriptions and not of limitation. There is no intention in the use of such terms and expressions of excluding the equivalents of the feature shown or described, or portions thereof, it being recognized that various modifications are possible within the scope of the invention as claimed.

1. A computer-based system for determining a flow rate of a liquid stream in substantially real-time, comprising:
(a) a vessel that will permit the liquid stream to fill the vessel at a natural flow rate of the liquid stream;
(b) a liquid stream control system under computer control for controlling filling and draining the vessel, with the liquid stream control stream controlling filling the vessel at the natural flow rate of the liquid stream;
(c) a first trigger mechanism disposed adjacent to the vessel, with the first trigger mechanism being activated when a level of the liquid filling the vessel is at a predetermined location with respect to the first trigger mechanism;
(d) a second trigger mechanism disposed adjacent to the vessel at a location different from the first trigger mechanism, with the second trigger mechanism being activated at a time after the first trigger mechanism is activated when the level of the liquid filling the vessel is at a predetermined location with respect the second trigger mechanism;
(e) a timer associated with the first and second trigger mechanisms for generating a timing signal indicative of the time interval between when the first trigger mechanism is activated and the second trigger mechanism is activated;
(f) a volume determining means for determining a volume of the vessel that was filled in the time interval between when the first trigger mechanism is activated and the second trigger mechanism is activated; and
(g) the computer for receiving the signal generated by the timer and volume from the volume determining means, and generating a flow rate for the liquid stream based on the signal generated by the timer and the volume from the volume determining means.

2. The system as recited in claim 1, wherein the vessel includes an elongated tubular member.

3. The system as recited in claim 1, wherein the liquid stream control system includes valve means for controlling filling and draining the vessel.

4. The system as recited in claim 3, wherein the valve means include a first pinch valve associated with an input section of the vessel for controlling filling the vessel and a second pinch valve associated with an output section of the vessel for controlling draining the vessel.

5. The system as recited in claim 1, wherein the first trigger mechanism includes a laser diode (“LD”)/photodiode pair or a light emitting diode (“LED”)/photodiode pair.

6. The system as recited in claim 1, wherein the second trigger mechanism includes a laser diode (“LD”)/photodiode pair or a light emitting diode (“LED”)/photodiode pair.

7. The system as recited in claim 1, wherein the liquid stream control system includes a controllable pumping means for controlling filling and draining the vessel.

8. The system as recited in claim 1, wherein the computer determines the flow rate according the expression:
$$FR = \frac{Volume}{Time}$$
Where,
FR=Flow rate of liquid stream
Volume=Volume from volume determining means
Time=Time value from timer.

9. A computer-based system for determining a flow rate of a liquid stream in substantially real-time, comprising:
(a) a vessel that will permit the liquid stream to fill the vessel at a natural flow rate of the liquid stream;
(b) a liquid stream control system under computer control for controlling filling and draining the vessel, with the liquid stream control stream controlling the filling the vessel at the natural flow rate of the liquid stream;
(c) a first trigger mechanism disposed adjacent to the vessel, with the first trigger mechanism being activated when a level of the liquid filling the vessel is at a predetermined location with respect to the first trigger mechanism;
(d) N trigger mechanisms disposed adjacent to the vessel at locations different from the first trigger mechanism and different from each other, with N≧1, and with the each of the N trigger mechanisms being activated at a time after the first trigger mechanism is activated when the level of the liquid filling the vessel is at a predetermined location with respect to each of the N trigger mechanisms;
(e) a timer associated with the first and N trigger mechanisms for generating a timing signal indicative of the time interval between when the first trigger mechanism and when any selected one of the N trigger mechanisms is activated;
(f) a volume determining means for determining a volume of the vessel that was filled in the time interval between when the first trigger mechanism is activated and when the selected one of the N trigger mechanisms is activated; and
(g) the computer for receiving the signal generated by the timer and volume from the volume determining means, and generating a flow rate for the liquid stream based on the signal generated by the timer and the volume from the volume determining means.

10. The system as recited in claim 9, wherein the vessel includes an elongated tubular member.

11. The system as recited in claim 9, wherein the liquid stream control system includes valve means for controlling the filling and draining of the vessel.

12. The system as recited in claim 11, wherein the valve means include a first pinch valve associated with an input section of the vessel for controlling filling the vessel and a second pinch valve associated with an output section of the vessel for controlling draining the vessel.

13. The system as recited in claim 9, wherein the first trigger mechanism includes a laser diode (“LD”)/photodiode pair or a light emitting diode (“LED”)/photodiode pair.

14. The system as recited in claim 9, wherein the second trigger mechanism includes a laser diode (“LD”)/photodiode pair or a light emitting diode (“LED”)/photodiode pair.

15. The system as recited in claim 9, wherein the liquid stream control system includes a controllable pumping means for controlling filling and draining the vessel.

16. The system as recited in claim 9, wherein the computer determines the flow rate according the expression:
$$FR = \frac{Volume}{Time}$$
Where,
FR=Flow rate of liquid stream
Volume=Volume from volume determining means
Time=Time value from timer.

17. A computer-based method for substantially continuously determining a flow rate of a liquid stream in substantially real-time, comprising the steps of:
(a) controlling with liquid stream control means for filling and draining a vessel with liquid from the liquid stream;
(b) setting the liquid stream control means for filling the vessel with liquid at a natural flow rate of the liquid stream;
(c) activating a first trigger means when a level of the liquid filling the vessel is at a predetermined location with respect to the first trigger means;
(d) activating a second trigger means at a time after the activation of the first trigger means when the level of the liquid filling the vessel is at a predetermined location with respect to the second trigger means;
(e) measuring with timer means the time interval between when the first trigger means is activated and the second trigger means is activated;
(f) determining with volume determining means a volume of the vessel that was filled in the time interval between when the first trigger means is activated and the second trigger means is activated;
(g) determining the flow rate of the liquid stream based on the time measured at step (e) and the volume determined at step (f);
(h) setting the liquid stream control means for draining the vessel; and
(i) repeating steps (b) to (h) for substantially continuously determining the flow rate of the liquid stream.

18. The method as recited in claim 17, wherein step (g) determines the flow rate according to the expression:
$$FR = \frac{Volume}{Time}$$
Where,
FR=Flow rate of liquid stream
Volume=Volume from step (f)
Time=Time from step (e).

19. The method as recited in claim 18, wherein the method further includes the step tracking the determinations of flow rate as a function of time for predetermined time period.

20. A computer-based method for substantially continuously determining a flow rate of a liquid stream in substantially real-time, comprising the steps of:
(a) controlling with liquid stream control means filling and draining a vessel with liquid from the liquid stream;
(b) setting the liquid stream control means for filling the vessel with liquid at a natural flow rate of the liquid stream;
(c) activating a first trigger means when a level of the liquid filling the vessel is at a predetermined location with respect to the first trigger means;
(d) activating a selected one of N trigger means at a time after the activation of the first trigger means when a level of the liquid filling the vessel is at a predetermined location with respect to the selected one of N trigger means, with N≧1;
(e) measuring with timer means the time interval between when the first trigger means is activated and when the selected one of N second trigger means is activated;
(f) determining with volume determining means a volume of the vessel that was filled in the time interval between when the first trigger means is activated and when the selected one of N trigger means is activated;
(g) determining the flow rate of the liquid stream based on the time measured at step (e) and the volume determined at step (f);
(h) setting the liquid stream control means for draining the vessel; and
(i) repeating steps (b) to (h) for substantially continuously determining the flow rate of the liquid stream.

21. The method as recited in claim 20, wherein step (g) determines the flow rate according to the expression:
$$FR = \frac{Volume}{Time}$$
Where,
FR=Flow rate of liquid stream
Volume=Volume from step (f)
Time=Time from step (e).

22. The method as recited in claim 21, wherein the method further includes the step of tracking the determinations of flow rate as a function of time for a predetermined time period.

23. A computer-based system for determining and monitoring a change in a level of a constituent in a liquid stream in substantially real-time to indicate an onset of a condition indicative of such change, comprising:
(a) a first subsystem for substantially continuously determining a flow rate of the liquid stream according to the expression:
$$FR = \frac{Volume}{Time}$$
Where,
FR=Flow rate of liquid stream
Volume=Volume filled at a natural flow rate of the liquid stream according to the “Time”
Time=Time to fill “Volume;”
(b) a second subsystem for substantially continuously determining a concentration of the constituent in the liquid stream;
(c) the computer for substantially continuously determining a mass excretion rate for the constituent in the liquid stream according to the expression:
$$\begin{matrix}ME = ( FR ) ( Concentration ) \\ ME = ( \frac{Volume}{Time} ) ( \frac{Mass}{Volume} ) = ( \frac{Mass}{Time} )\end{matrix}$$
Where,
ME=Mass excretion rate of constituent
FR=Flow rate of liquid stream
Volume=Volume filled at a natural flow rate of the liquid stream according to “Time”
Time=Time to fill “Volume”
Mass=Measured mass of constituent in liquid/Volume; and
(d) monitoring means for substantially continuously monitoring the mass excretion rate of the constituent in the liquid stream for changes indicative an onset of the condition indicative of such change.

24. The system as recited in claim 23, wherein the first subsystem for substantially continuously determining the flow rate of the liquid stream, further comprises,
(1) a vessel that will permit the liquid stream to fill the vessel at a natural flow rate of the liquid stream,
(2) a liquid stream control system under computer control for controlling filling and draining the vessel, with the liquid stream control stream controlling filling the vessel at the natural flow rate of the liquid stream,
(3) a first trigger mechanism disposed adjacent to the vessel, with the first trigger mechanism being activated when a level of the liquid filling the vessel is at a predetermined location with respect to the first trigger mechanism,
(4) a second trigger mechanism disposed adjacent to the vessel at a location different from the first trigger mechanism, with the second trigger mechanism being activated at a time after the first trigger mechanism is activated when the level of the liquid filling the vessel is at a predetermined location with respect the second trigger mechanism,
(5) a timer associated with the first and second trigger mechanisms for generating a timing signal indicative of the time interval between when the first trigger mechanism is activated and the second trigger mechanism is activated,
(6) a volume determining means for determining a volume of the vessel that was filled in the time interval between when the first trigger mechanism is activated and the second trigger mechanism is activated, and
(7) the computer receives the signal generated by the timer and volume from the volume determining means, and generates a flow rate for the liquid stream based on the signal generated by the timer and the volume from the volume determining means.

25. The system as recited in claim 24, wherein the vessel includes an elongated tubular member.

26. The system as recited in claim 24, wherein the liquid stream control system includes valve means for controlling filling and draining the vessel.

27. The system as recited in claim 26, wherein the valve means include a first pinch valve associated with an input section of the vessel for controlling filling the vessel and a second pinch valve associated with an output section of the vessel for controlling draining the vessel.

28. The system as recited in claim 24, wherein the first trigger mechanism includes a laser diode (“LD”)/photodiode pair or a light emitting diode (“LED”)/photodiode pair.

29. The system as recited in claim 24, wherein the second trigger mechanism includes a laser diode (“LD”)/photodiode pair or a light emitting diode (“LED”)/photodiode pair.

30. The system as recited in claim 24, wherein the liquid stream control system includes a controllable pumping means for controlling filling and draining the vessel.

31. The system as recited in claim 23, wherein the first subsystem for substantially continuously determining the flow rate of the liquid stream, further comprises,
(1) a vessel that will permit the liquid stream to fill the vessel at a natural flow rate of the liquid stream,
(2) a liquid stream control system under computer control for controlling filling and draining the vessel, with the liquid stream control stream controlling filling the vessel at the natural flow rate of the liquid stream,
(3) a first trigger mechanism under computer control disposed adjacent to the vessel, with the first trigger mechanism being activated when a level of the liquid filling the vessel is at a predetermined location with respect to the. first trigger mechanism,
(4) N trigger mechanisms under disposed adjacent to the vessel at locations different from the first trigger mechanism and different from each other, with N≧1, and with the each of the N trigger mechanisms being activated at a time after the first trigger mechanism is activated when the level of the liquid filling the vessel is at a predetermined location with respect to each of the N trigger mechanisms,
(5) a timer associated with the first and N trigger mechanisms for generating a timing signal indicative of the time interval between when the first trigger mechanism and when any selected one of the N trigger mechanisms is activated,
(6) a volume determining means for determining a volume of the vessel that was filled in the time interval between when the first trigger mechanism is activated and when the selected one of the N trigger mechanisms is activated, and
(7) the computer for receiving the signal generated by the timer and volume from the volume determining means, and generating a flow rate for the liquid stream based on the signal generated by the timer and the volume from the volume determining means.

32. The system as recited in claim 31, wherein the vessel includes an elongated tubular member.

33. The system as recited in claim 31, wherein the liquid stream control system includes valve means for controlling the filling and draining of the vessel.

34. The system as recited in claim 33, wherein the valve means include a first pinch valve associated with an input section of the vessel for controlling filling the vessel and a second pinch valve associated with an output section of the vessel for controlling draining the vessel.

35. The system as recited in claim 31, wherein the first trigger mechanism includes a laser diode (“LD”)/photodiode pair or a light emitting diode (“LED”)/photodiode pair.

36. The system as recited in claim 31, wherein the second trigger mechanism includes a laser diode (“LD”)/photodiode pair or a light emitting diode (“LED”)/photodiode pair.

37. The system as recited in claim 31, wherein the liquid stream control system includes a controllable pumping means for controlling filling and draining the vessel.

38. The system as recited in claim 23, wherein the second subsystem for determining the concentration of the constituent in the liquid stream, further comprises,
(1) an energy source that is capable of being controlled to excite the constituent in the liquid stream to produce a spectral response in a known frequency band when such constituent is exposed to the energy source;
(2) a spectrometer that is capable of being controlled to detect the spectral response produced by the constituent when exposed to the energy source; and
(3) the computer being capable of processing the spectral response detected by the spectrometer to generate a measurement of a concentration of constituent in the liquid stream.

39. The system as recited in claim 38, wherein the energy source includes a Raman laser.

40. The system as recited in claim 38, wherein the spectrometer includes a Raman spectrometer.

41. The system as recited in claim 23, wherein the monitor means includes a graphical display for displaying the mass excretion rate of the constituent.

42. The system as recited in claim 23, wherein the monitor means includes a graphical display for displaying the flow rate of the liquid stream.

43. The system as recited in claim 23, wherein the monitor means includes a video display for displaying the mass excretion rate of the constituent.

44. The system as recited in claim 23, wherein the system further includes an alarm that may be activated if there is a change in the mass excretion rate of the constituent in the liquid stream indicative of the onset of the condition indicative of such change.

45. The system as recited in claim 23, wherein the liquid stream includes a urine stream.

46. The system as recited in claim 45, wherein the constituent includes creatinine.

47. The system as recited in claim 45, wherein the constituent includes urea.

48. A computer-based method for determining and monitoring a change in a level of a constituent in a liquid stream in substantially real-time to indicate an onset of a condition indicative of such change, comprising:
(a) substantially continuously determining a flow rate of the liquid stream according to the expression:
$$FR = \frac{Volume}{Time}$$
Where,
FR=Flow rate of liquid stream
Volume=Volume filled at a natural flow rate of the liquid stream according to the “Time”
Time=Time to fill “Volume;”
(b) substantially continuously determining a concentration of the constituent in the liquid stream;
(c) substantially continuously determining a mass excretion rate for the constituent in the liquid stream according to the expression:
$$\begin{matrix}ME = ( FR ) ( Concentration ) \\ ME = ( \frac{Volume}{Time} ) ( \frac{Mass}{Volume} ) = ( \frac{Mass}{Time} )\end{matrix}$$
Where,
ME=Mass excretion rate of constituent
FR=Flow rate of liquid stream
Volume=Volume filled at a natural flow rate of the liquid stream according to “Time”
Time=Time to fill “Volume”
Mass=Measured mass of constituent in liquid/Volume; and
(d) substantially continuously monitoring the mass excretion rate of the constituent in the liquid stream for a change indicative of the onset of the condition indicative of such change.

49. The method as recited in claim 48, wherein the step of substantially continuously determining the flow rate of the liquid stream, further comprises the substeps of,
(1) controlling with liquid stream control means for filling and draining a vessel with liquid from the liquid stream,
(2) setting the liquid stream control means for filling the vessel with liquid from the liquid stream at a natural flow rate of the liquid stream,
(3) activating a first trigger means when a level of the liquid filling the vessel is at a predetermined location with respect to the first trigger means,
(4) activating a second trigger means at a time after the activation of the first trigger means when the level of the liquid filling the vessel is at a predetermined location with respect to the second trigger means,
(5) measuring with timer means the time interval between when the first trigger means is activated and the second trigger means is activated,
(6) determining with volume determining means a volume of the vessel that was filled in the time interval between when the first trigger means is activated and the second trigger means is activated,
(7) determining the flow rate of the liquid stream based on the time measured at step (5) and the volume determined at step (6),
(8) setting the liquid stream control means for draining the vessel, and
(9) repeating steps (2) to (8) for substantially continuously determining the flow rate of the liquid stream.

50. The method as recited in claim 48, wherein the step of substantially continuously determining the flow rate of the liquid stream, further comprises the substeps of,
(1) controlling with liquid stream control means for filling and draining a vessel with liquid from the liquid stream,
(2) setting the liquid stream control means for filling the vessel with liquid from the liquid stream at a natural flow rate of the liquid stream,
(3) activating a first trigger means when a level of the liquid filling the vessel is at a predetermined location with respect to the first trigger means,
(4) activating a selected one of N trigger means at a time after the activation of the first trigger means when the level of the liquid filling the vessel is at a predetermined location with respect to the selected one of N trigger means, with N≧1,
(5) measuring with timer means the time interval between when the first trigger means is activated and when the selected one of N second trigger means is activated,
(6) determining with volume determining means a volume of the vessel that was filled in the time interval between when the first trigger means is activated and when the selected one of N trigger means is activated,
(7) determining the flow rate of the liquid stream based on the time measured at step (e) and the volume determined at step (f),
(8) setting the liquid stream control means for draining the vessel, and
(9) repeating steps (2) to (8) for substantially continuously determining the flow rate of the liquid stream.

51. The method as recited in claim 50, wherein the method further includes the substep of tracking the determinations of flow rate as a function of time for a predetermined time period.

52. The method as recited in claim 48, wherein the step of substantially continuously determining the concentration of the constituent in the liquid stream, further comprises the substeps of,
(1) irradiating the liquid stream containing the constituent with an energy source and exciting the constituent to produce a spectral response in a known frequency band to indicate the amount of the constituent in the volume;
(2) detecting the spectral response produced by the constituent when exposed to the energy source at step (1); and
(3) the computer processing the spectral response detected by the spectrometer and generating a measurement of a concentration of constituent in the liquid stream.

53. The method as recited in claim 48, wherein the method further includes the step of activating an alarm if there is a change in the mass excretion rate of the constituent in the liquid stream that is indicative of the onset of the condition indicative of such change.

54. The method as recited in claim 48, wherein the liquid stream includes a urine stream.

55. The method as recited in claim 54, wherein the constituent includes creatinine.

56. The method as recited in claim 54, wherein the constituent includes urea.

57. The method as recited in claim 48, wherein the liquid stream includes being input from catheter.

58. The method as recited in claim 57, wherein the liquid stream includes being input from a Foley catheter.

59. The method as recited in claim 48, wherein the method further includes setting an alarm to be activated when the change is indicative of an onset of kidney dysfunction.

60. The method as recited in claim 48, wherein the method further includes setting an alarm to be activated when the change is indicative of an onset of oliguria.

61. The method as recited in claim 48, wherein the method further includes setting an alarm to be activated when the change is indicative of an onset of dehydration in a patient.

62. The method as recited in claim 48, wherein the method further includes setting an alarm to be activated when the change is indicative of an onset of Acute Renal Failure.

63. The method as recited in claim 48, wherein the method further includes monitoring for a general health of an organ system.

64. The method as recited in claim 48, wherein the method further includes monitoring for a recovery from a disease condition.

65. The method as recited in claim 64, wherein the method further includes monitoring for recovery from Acute Renal Failure.

66. The method as recited in claim 48, wherein the method further includes monitoring for a recovery from dialysis.

67. The system as recited in claim 23, wherein the vessel includes being disposable.

68. The system as recited in claim 23, wherein the monitor means includes a video display for displaying the flow rate of the liquid stream.

69. The system as recited in claim 23, wherein the system further includes an alarm that may be activated if there is a change in the flow rate of the liquid stream indicative of the onset of the condition indicative of such change.

70. The method as recited in claim 48, wherein the method further includes activating an alarm if there is a change in the flow rate of the liquid stream indicative of the onset of the condition indicative of such change.
